(19) United States
(12) Patent Application Publication
(10) Pub. No.: US 2024/0297595 A1
(43) Pub. Date: Sep. 5, 2024

(54) DUTY CYCLE CONTROL IN POLYPHASE WIRELESS POWER TRANSFER SYSTEMS

(71) Applicant: Auckland UniServices Limited, Auckland (NZ)

(72) Inventors: Duleepa Jayanath THRIMAWITHANA, Auckland (NZ); Osama Abdulameer Ali Ahmed Ali ALMULLA, Auckland (NZ)

(21) Appl. No.: 18/261,794

(22) PCT Filed: Jan. 24, 2022
(86) PCT No.: PCT/IB2022/050608

§ 371 Date: Jul. 17, 2023

(30) Foreign Application Priority Data
Jan. 22, 2021 (NZ) 772229

(51) Int. Cl. H02M 7/5387; H02J 50/12; H02M 1/00; H02M 7/5395

(52) U.S. Cl. CPC H02M 7/53871; H02J 50/12; H02M 1/0058; H02M 7/5395

(57) ABSTRACT

A method of controlling a polyphase wireless power transfer coupler includes using duty cycle control to switch a polyphase converter to produce a periodic asymmetric voltage waveform across the phase windings.

This disclosure relates to converter control for wireless power transfer systems that utilise more than one phase (i.e. polyphase wireless power transfer systems). Several exemplary converter modulation schemes are described to demonstrate how duty cycle modulation of the phase voltages can be used to control power transfer from a wireless power transfer coupler or to a wireless power transfer secondary.

### BACKGROUND

Inductive power transfer (IPT) is a wireless power transfer technology that allows power to be delivered wirelessly. Compared to conductive (wired) power transfer, it is considered a safer method to deliver power and it can be employed in dusty or wet environments. Due to this, it has found use in many applications such as automatically guided vehicles, clean rooms, and electric vehicle (EV) charging.

In the application of EV charging, high-power IPT systems allow the charging time to be reduced and they are therefore desirable. IPT systems are composed of a primary and secondary side. Typically, the primary side of IPT systems consists of a low-frequency AC to DC converter followed by a DC to high-frequency AC converter which connects to the primary coil magnetic coupling structure (often referred to as a coupler or pad) through a tuning network. The primary and secondary sides are magnetically coupled which produces a mutual inductance, M, between them. The secondary side follows a similar coupler or pad and can feature an active or passive bridge depending in part on whether bidirectional operation is needed. A DC-DC converter also optionally appears in some secondary circuits to better regulate the output power and voltage. Multi-phase IPT systems follow a similar structure, though they utilise multi-phase converters. The couplers or pads in a multiphase IPT system can be single-phase or multi-phase.

There are multiple important standards that need to be considered when designing an IPT system for EV charging. SAE J2954 is one such standard, which details interoperability, safety and usability requirements that must be met by a wireless EV charger. SAE J2954 sets the tuned frequency of the resonant network, ff0, of an IPT based EV charger to 85 kHz, and it defines power classes WPT1-5, which range from 3.7 kW to 50 kW. The tuned frequency of 85 kHz can lead to high switching losses, especially if the devices hard-switch.

Multi-phase IPT systems are suitable for high-power applications and they also have the advantage of sustaining smaller current stresses in devices for any given power level compared to their single-phase counterparts. Previous research has shown that 3-phase IPT systems can be used to increase the tolerance to misalignments, as well as mitigate EMI issues. However, the increased size and the complexity of 3-phase systems is one of their drawbacks. The use of three-phase converters also means that the control methods utilised in single-phase systems cannot necessarily be directly applied to three-phase systems.

There are several topologies that are used as the power converter in 3-phase IPT systems that utilise 3-phase pads. These include using three separate full bridges, a single six-switch three-leg full-bridge inverter, or a four-leg inverter that uses the last leg as a neutral.

A commonly used control technique in three-leg full bridge inverters is the standard six-step modulation as described in G. A. Covic, J. T. Boys, M. L. G. Kissin and H. G. Lu, “A Three-Phase Inductive Power Transfer System for Roadway-Powered Vehicles,” IEEE Transactions on Industrial Electronics, vol. 54, pp. 3370-3378, 2007. This involves fixing all the leg duty cycles to 50% and phase-shifting their outputs by 120° with respect to each other. The bridge currents can then be controlled by controlling the DC-link voltage. This allows for full control over the currents but requires extra circuitry to regulate the DC voltage.

In order to address this issue, a variable output voltage (VOV) modulation technique has been proposed in G. A. Covic, J. T. Boys, M. L. G. Kissin and H. G. Lu, “A Three-Phase Inductive Power Transfer System for Roadway-Powered Vehicles,” IEEE Transactions on Industrial Electronics, vol. 54, pp. 3370-3378, 2007. This technique operates by inserting a notch at θθnn+60° and a pulse at θθnn+240° in the line-to-neutral voltages. Where θθnn is the starting angle of each period of the line-to-line voltage (i.e. θθaa=0°, θθbb=120°, and θθcc=240°). The pulse and notch widths are kept equal, and their width can range from ϕϕnnnnnncch=0° to 60°. At ϕϕnnnnnncch=0°, the resulting line-to-line waveform is the standard six-step waveform. In contrast, at ϕϕnnnnnncch=60° the resulting line-to-line voltages are zero. Therefore, the bridge current can be fully controlled through controlling the notch width (ϕϕnnnnnncch). Additionally, due to the placement of the pulses and notches, the third harmonic content in the waveform can be controlled as explained in that paper. The symmetry of the line-to-line waveforms resulting from the VOV modulation also leads to the total harmonic distortion (THD) being low.

Yet another control technique that has been utilised is space vector modulation (SVM), described in J. Noeren, N. Parspour and B. Sekulic, “A Direct Matrix Converter with Space Vector Modulation for Contactless Energy Transfer Systems,” in 2018 IEEE 18th International Power Electronics and Motion Control Conference (PEMC), 2018. However, this control scheme is more complicated and often leads to higher switching frequencies.

The aforementioned control techniques have some issues or limitations in IPT applications. Namely, the six-step modulation needs to regulate the DC voltage in order to control the track currents. The insertion of pulses and notches in the VOV method is problematic as it consequently means that the switches must operate at 3 times the tuned frequency. This is an issue as it exacerbates the switching losses. Finally, SVM is not only more complicated to implement, but also runs into the issue of operating at higher frequencies.

### SUMMARY OF THE DISCLOSURE

A method of controlling a polyphase wireless power transfer primary or secondary is disclosed. The method comprises switching a polyphase converter to produce a periodic asymmetric voltage waveform across at least one of the phase windings of a polyphase wireless power transfer coupler such as a primary or secondary. The asymmetry in the voltage waveform can comprise phase and/or amplitude asymmetry. For example, the phase-to-phase voltage waveform (also referred to as the line-to-line voltage waveform) can be shifted, skewed or weighted to the start or end of each cycle. Although the examples disclosed below refer primarily to a wireless power transfer primary, those skilled in the art will understand that a wireless power transfer secondary or pick-up can include a converter that can be controlled using the duty cycle principles disclosed herein to control the currents and/or voltages in compensated phase windings to thereby control the transfer to power to a load connected to the secondary. Control of power flow may be achieved for example through phase angle control techniques such as those disclosed in PCT/NZ2009/000259. It will also be understood that this disclosure is applicable to bi-directional IPT systems.

In some embodiments, the method comprises controlling power transfer from the polyphase wireless power transfer primary or secondary by modulating the switching duty cycle for each of the phase windings.

The method can comprise independently controlling the switching duty cycle for each of the phase windings to compensate for misalignment between the polyphase wireless power transfer primary and a wireless power transfer secondary. Alternatively, the method can comprise switching each of the phase windings with substantially the same duty cycle.

In at least some embodiments, the method comprises switching each of the phase windings at a frequency that does not exceed a resonant frequency of the wireless power transfer primary or secondary. This includes switching each of the phase windings at a frequency that substantially corresponds to a resonant frequency of the polyphase wireless power transfer primary or secondary.

In some embodiments, the method comprises switching each of the phase windings at a frequency that corresponds to a resonant frequency of the corresponding phase winding and regulating the voltage applied to the resonant circuit of each of the phase windings to control the current circulating in the resonant circuit.

The method can comprise regulating the periodic asymmetric voltage waveform across each of the phase windings to control the circulating current in a compensation network of each of the phase windings. This can comprise regulating the periodic asymmetric voltage waveform to control the RMS current in each of the phase windings.

In some embodiments, the phase windings of the polyphase wireless power transfer coupler consist of a first phase winding and a second phase winding, and the method comprises switching the second phase winding 180° out of phase with the first phase winding. In some embodiments a first phase winding, a second phase winding and a third phase windings are provided, and the method comprises switching the phase windings 120° out of phase. In some embodiments the method comprises switching the phase windings 360°/n out of phase, where n is the number of phase windings.

A method of switching a polyphase converter is also disclosed. The method comprises switching the polyphase converter at the resonant frequency of a polyphase wireless power transfer coupler and controlling power transfer from the polyphase wireless power transfer coupler by modulating the switching duty cycle of the phases.

In some embodiments, the method comprises switching the polyphase converter to produce a symmetric phase-to-neutral voltage waveform (also referred to as a line-to-neutral voltage waveform) for each of the phases of polyphase wireless power transfer coupler. The method can also comprise switching the polyphase converter to produce an asymmetric phase-to-phase voltage waveform (also referred to as a line-to-line voltage waveform).

The method can comprise controlling the switching duty cycle of each of the phases of the polyphase wireless power transfer coupler to introduce an imbalance between at least two of the phases. In some embodiments, this can be achieved by switching each of the phases of the polyphase wireless power transfer coupler with a different duty cycle to create a DC bias. In some embodiments, the method comprises filtering a DC bias across at least one phase of the polyphase wireless power transfer coupler with a compensation network of at least one phase.

The method can comprise modulating the switching duty cycle of the phases of the polyphase wireless power transfer coupler to create a phase asymmetry in a phase-to-phase voltage waveform and a pulse width asymmetry in the phase-to-phase voltage waveform. For example, the converter can be controlled to produce positive pulses that have a greater width than the negative pulses (and vice versa).

In some embodiments, the method comprises independently modulating a relative phase angle between the phases of the polyphase wireless power transfer coupler. The method can comprise independently modulating a relative phase angle between the phases of the polyphase wireless power transfer coupler. In at least some embodiments, the DC voltage input to the polyphase converter can be controlled to modulate the voltage amplitude of the phases of the polyphase wireless power transfer coupler.

Several examples are presented in the following description and appended documents. They are intended to demonstrate how embodiments of a polyphase wireless power transfer coupler can be operated to control the power made available to a wireless power pickup (also referred to as a wireless power transfer secondary). They are not intended to be a comprehensive description of all possible alternatives and the inventors envisage alterations that are within the ability of a person having ordinary skill in the art of power electronics (as used for wireless power systems).

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

As used herein the term “and/or” means “and” or “or”, both. As used herein “(s)” following a noun means the plural and/or singular forms of the noun. The term “comprising” as used in this specification means “consisting at least in part of”. When interpreting statements in this specification which include that term, the features prefaced by that term in each statement all need to be present, but the other features can also be present. Related terms such as “comprise” and “comprised” are to be interpreted in the same matter. The entire disclosures of all applications, patents and publications, cited above and below, if any, are hereby incorporated by reference.

The invention consists in the foregoing and also envisages constructions of which the following gives examples only.

### BRIEF DESCRIPTION OF THE FIGURES

FIG. 1: Six-leg 3-phase full-bridge inverter.

FIG. 2: Duty cycle modulation.

FIG. 3: Standard six-step waveform.

FIG. 4: Regions for modulation of line-to-line voltages

FIG. 5: Normalised fundamental frequency as a function of the bridge legs' conduction angle.

FIG. 6: Line to line waveform depicting the angles used to define Equation (1)

FIG. 7: THD as a function of the normalised fundamental component.

FIG. 8: Delta-Delta 3-phase LCL system.

FIG. 9: Simulation results for full-current.

FIG. 10: Simulation results for half-current.

FIG. 11: X-Y View of surface plots showing how the fundamental components of the line-to-line voltages change with the control angles. The Z-values, which represent V_LL values, are shown as a colourmap.

FIG. 12: Simulation results for ϕ_a=290°, ϕ_b=70°, and ϕ_c=180°.

FIG. 13: Simulation results for alternate method to turn off one line-to-line voltage.

FIG. 14: Simulation results for ϕ_A=150°, ϕ_B=270°, and ϕ_C=360°.

### DESCRIPTION

One embodiment proposed in this description is to use duty cycle modulation, while switching at the tuned frequency, in three-phase IPT systems that employ standard two-level inverters/BAB's/IBMC's to produce a controllable current in the transmitter/receiver coil.

Unlike conventional modulation schemes, which either require additional circuitry to control the DC-link voltage or need to switch the inverter at three times the tuned frequency, the proposed scheme relies on generating an asymmetric output that has a controllable amplitude or fundamental amplitude. By controlling the asymmetry through the duty cycle of the switches, the fundamental component of the bridge output voltage can be controlled and hence the track current can be controlled. It should be noted that while the resultant line-to-line waveform is asymmetrical the positive and negative pulses will always have the same width, so long as the duty cycles of the line voltages are symmetrical.

Furthermore, the duty cycles can also be made to be asymmetrical to introduce imbalances in the line-to-line voltages. This can be used to better control the system under misalignment conditions. This results in an asymmetrical line-to-line voltage where the positive and negative pulses have unequal widths.

Since it is utilised in an IPT system that has a bandpass response, DC biases can be tolerated as they are filtered out and hence cannot saturate the couplers. These can arise from, as examples, unideal behaviour in practical conditions or from the introduced imbalances in the line-to-line voltages.

One advantage that this technique has over conventional six-step modulation is that it can control the current without needing to vary the DC-link voltage. This, in turn, means that it reduces the number of necessary components. It also has advantages over variable output voltage (VOV) control. For example, it can operate with a switching frequency equal to the tuned frequency, rather than needing to operate at a frequency three times higher. This means that switching losses can be considerably reduced.

In some embodiments, the resonant network of a tuned IPT system can be used to filter harmonics produced by the asymmetrical voltage waveform. This can reduce losses in the magnetic components and the conduction losses of the converter. The bandpass nature of IPT systems also means that the duty cycles can be made asymmetrical since DC biases are eliminated. DC biases are typically not tolerated by a non-resonant system (such as transformers) because they saturate the magnetics (e.g. the transformer core). The ability to utilise asymmetrical duty cycles is beneficial in that it allows for each of the phases to be excited to varying degrees, which can prove to be useful when the couplers (e.g. the primary and secondary coils) become misaligned.

The disclosed modulation scheme can be used for a wide range of wireless power transfer applications. One example is Electric Vehicle (EV) charging. High power IPT systems that are designed for use in EV charging must comply with the SAE J2954 standard, which dictates a nominal operating frequency of 85 kHz. At such frequency, the switching losses of the converter is a prominent concern.

When it comes to polyphase (e.g. three-phase) IPT applications, driving the inverter with the traditional six-step modulation requires other components to control the DC-link voltage so as to achieve control over the bridge current. Using VOV control, on the other hand, requires switching the inverter at three times the tuned frequency which can lead to significant switching losses. The proposed modulation scheme is capable of controlling the current without requiring an additional DC-DC converter and it does so while switching the inverter at the tuned frequency. This will thereby reduce switching losses significantly, while also reducing the number of components needed.

Duty cycle modulation can be used to control the polyphase converter of an IPT system. By utilising resonant networks, the switches can be made to soft-switch and the harmonics produced through this modulation scheme can be filtered out. The nature of the application also allows the control method to be extended by using asymmetrical duty cycles when necessary. This is particularly useful as it allows the track currents to be made unequal, which can help control the power under misaligned conditions. A three-phase example is presented in this description to demonstrate how asymmetric line-to-line voltages can be used to control power transfer from an IPT primary. The disclosure is equally applicable to other polyphaser systems (including two-phase systems).

The disclosed modulation scheme can be applied to wireless charging systems that utilise a standard 3-phase full-bridge inverter. There is also potential to apply this modulation scheme to other 3-phase IPT power supplies, such as those that are based on boost active bridge (BAB) or IBMC technology.

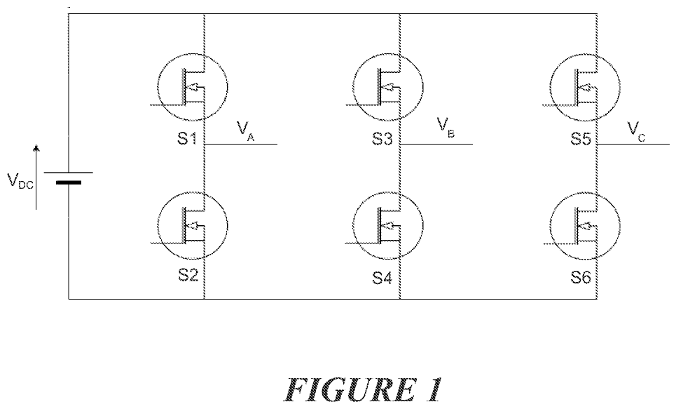

Full-bridge inverters used in 3-phase IPT systems are typically operated with a standard six-step waveform. However, this does not allow the inverter to control the bridge current and consequently requires another converter to adjust the DC-link voltage in order to control the current. Variable output voltage (VOV) control was proposed in the literature as a method to overcome this, while also controlling the 3rd harmonic content within the waveform. In addition, the symmetry of the resulting line-to-line voltages means that the total harmonic distortion (THD) is low. A 3-phase full-bridge inverter is shown in FIG. 1.

The VOV control scheme works by inserting a notch at θ_n+60° and a pulse at θ_n+240° in the line-to-neutral voltages. Where θ_n is the angle where the cycle of the line-to-line voltage starts. The pulse and notch widths are kept equal, and their width can range from ϕ_notch=0° to 60°. At ϕ_notch=0°, the resulting line-to-line waveform is the standard six-step waveform. In contrast, at ϕ_notch=60°, the resulting line-to-line voltages are zero. Therefore, the bridge current can be fully controlled by controlling the notch width (ϕ_notch).

The main drawback of using the VOV method, as stated before, is that each switching device must switch six times in each cycle. In other words, the switching frequency is three times the tuned frequency of the system. This is problematic when the tuned frequency is 85 kHz, as it would result in significant switching losses. This is made worse because some edges are likely to hard-switch, due to the high switching frequency, even when the tuning network is detuned to allow for more soft-switching to occur.

Duty cycle control has been explored to a limited extent in 3-phase single active bridge (SAB) DC-DC converters as a means to control them. Three-phase SAB's have a 3-phase transformer in the middle, and previous research has examined the operation of these systems under duty cycle control when the transformers were in delta-wye or wye-wye configurations. However, there are some key differences between these applications and IPT applications. Most prominently, an IPT application requires power transfer to occur across an airgap whilst the magnetic couplers are loosely coupled. Due to this, resonant networks and higher operating frequencies are employed. The higher operating frequency makes it important to soft-switch the converters in the IPT application. Moreover, IPT systems must take the alignment of couplers into account.

Duty cycle modulation in 3-phase SAB's achieves ZVS due to incorporating the leakage inductance into the design. An IPT system, by comparison, can utilise a number of different tuning networks such as series L-C, parallel L-C, and LCL compensation to name a few. Furthermore, the primary and secondary couplers can have different compensation schemes. Nevertheless, these resonant networks can be detuned in order to ensure that an IPT system achieves ZVS as well. The tuning networks can also be used to filter out harmonics in order to reduce the conduction losses in the converter. This is an advantage that SAB's lack due to the absence of a resonant network. Additionally, the tuning of IPT systems allows for the prevention of saturating the magnetic cores due to DC biases. This makes it possible to expand upon the modulation scheme by using asymmetrical duty cycles, which is another key difference to the SAB applications.

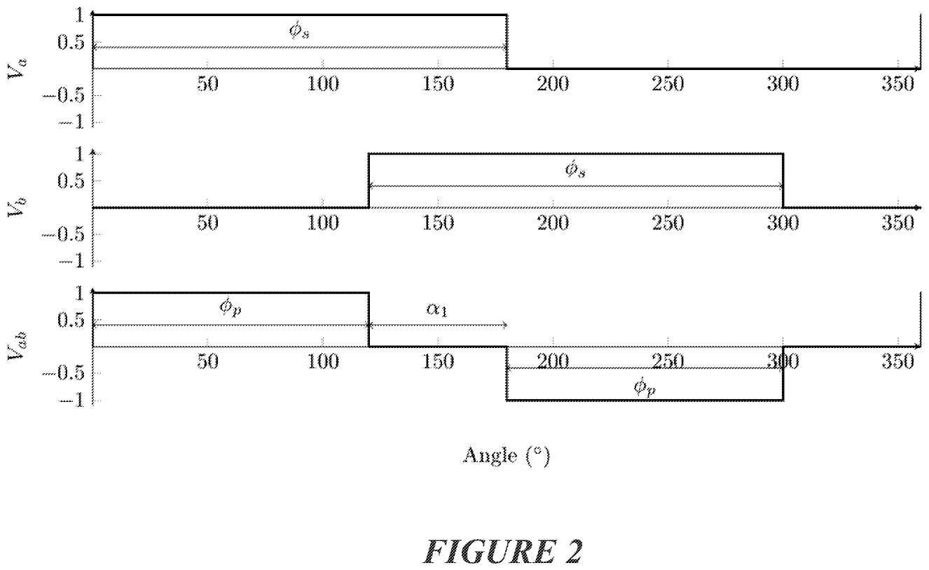

In order to overcome the issues presented by the VOV scheme, whilst still maintaining full control over the bridge current, duty cycle control is proposed as an alternative method to drive multi-phase (in this example 3-phase) IPT systems. In duty cycle control, the line-to-neutral voltages are kept 120° out of phase. The duty cycle can then be adjusted in order to adjust the resulting line-to-line voltages. The following overview and analysis is based on operating with equal duty cycles (i.e. symmetrical duty cycles), and asymmetrical duty cycles are discussed afterwards. FIG. 2 illustrates an example of utilising equal duty cycles, where the voltages are normalised about their maximum values. In the figure, ϕ_s is the control angle and can be changed from 0° to 360° while ϕ_p and α_1 are resulting angles in the line-to-line voltage that are important for analysing the output behaviour. This is further discussed below.

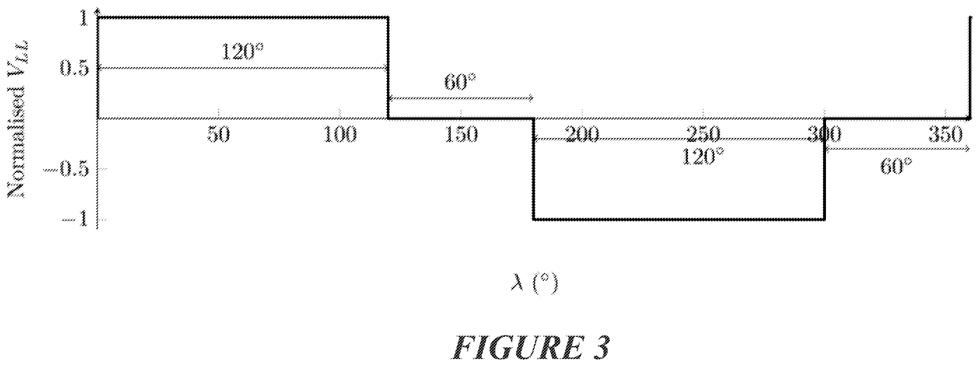

When the duty cycle is kept at 50%, the resulting line-to-line waveform is the standard six-step waveform as shown in FIG. 3. If the duty cycle is decreased or increased, then the resulting line-to-line waveform will be asymmetrical. Nevertheless, the fundamental component will decrease and reach 0 as the duty cycle approaches 0% or 100%. Due to this, it is possible to fully control the bridge current by controlling the inverter. This is illustrated in the section below, where the different operating regions are discussed.

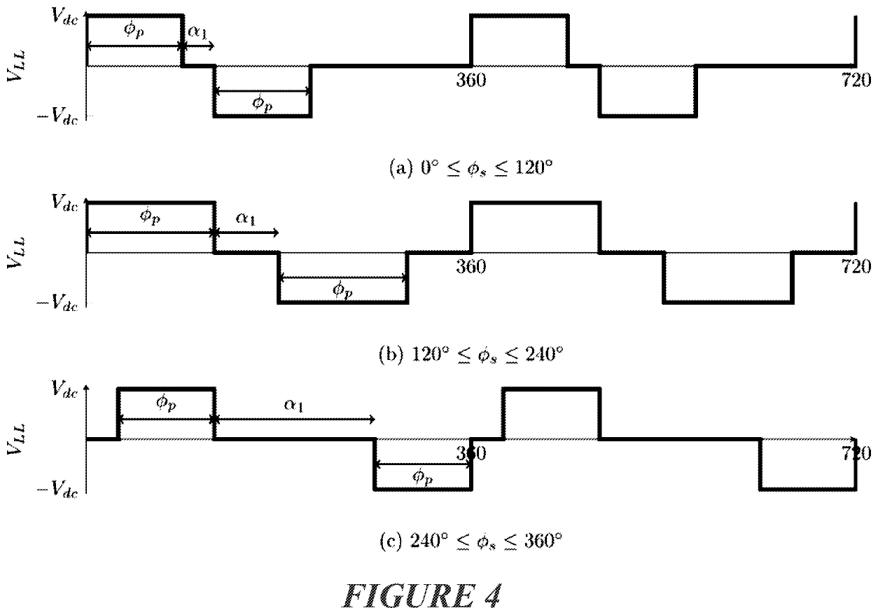

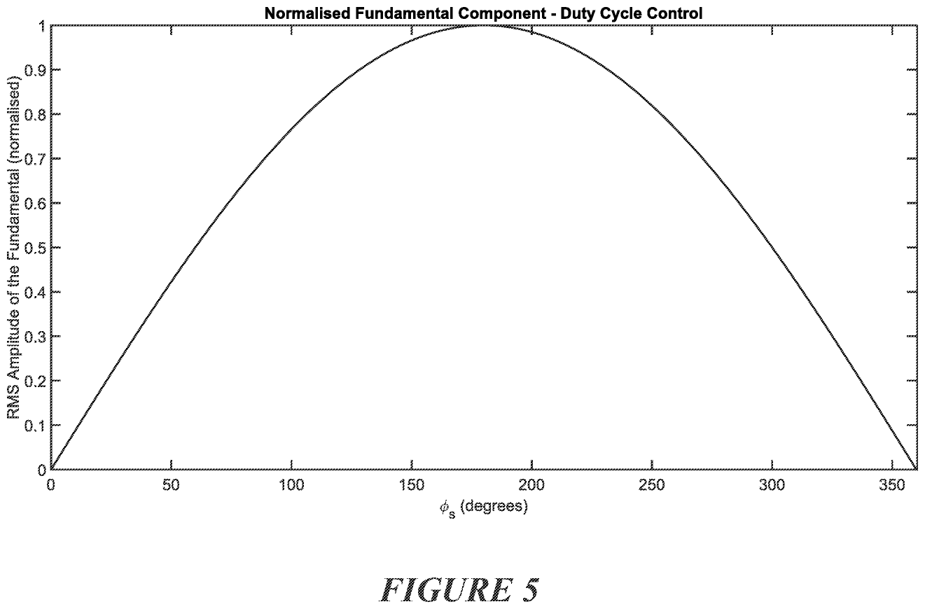

When operating a standard 3-phase full-bridge inverter with this modulation scheme, with symmetrical duty cycles, there are 3 regions of operation. The three operating regions can be observed as the conduction angle of the switches is changed from 0° to 360° (or equivalently the duty cycle changes from 0% to 100%). These are when the duty cycle is between 0 to 1/3, 1/3 to 2/3, and 2/3 to 1, and are shown in FIGS. 4(a), 4(b) and 4(c) respectively. The operating modes are symmetrical about a 50% duty cycle) (ϕ_s=180° in the sense that if the duty cycle is decreased or increased by a certain value, then the decrease in the fundamental component will be the same in both cases. This is shown in FIG. 5.

For duty cycles of 1/3 to 2/3, the pulse width in the line-to-line voltage does not change (i.e. ϕ_p remains at 120°). However, the negative pulse shifts with respect to the positive pulse, creating an asymmetrical V_LL, and as a result, the fundamental component decreases and the THD increases. In the two other regions, where the duty cycle is 0 to 1/3 or 2/3 to 1, this trend continues whereby the fundamental component continues to decrease as the duty cycle moves further away from 50%. The difference, however, is that the line-to-line pulse width, ϕ_p, also starts to decrease down towards a conduction angle of 0° (which is reached when ϕ_s is 0° or 360°). This is shown in FIG. 4. Thus the fundamental component of the line-to-line voltage can be controlled and, since the bridge current depends on that fundamental component, hence the bridge (i.e. converter) current can be fully controlled.

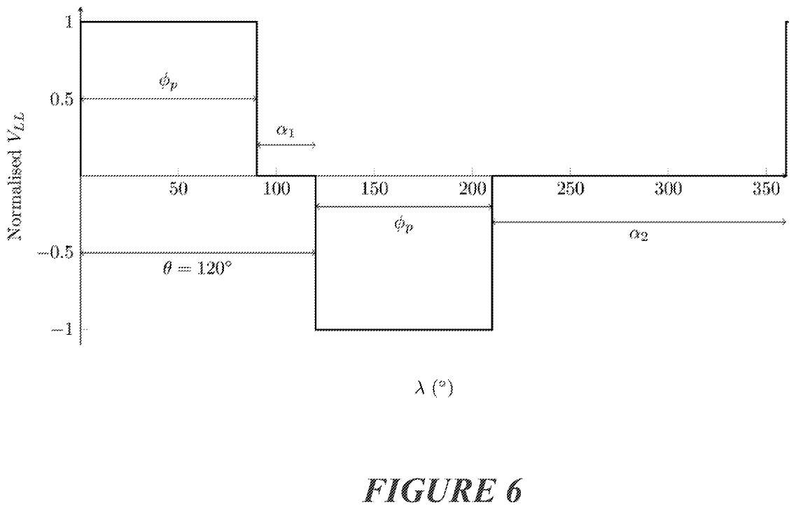

The Fourier Series description of the line-to-line voltage (V_LL) for any operating point can be given as:

$${V}_{LL} ( λ ) = {{\sum }_{n = 1}^{∞}}_{n ∈ ℕ} \frac{1}{n} cos ( \frac{n πλ}{180} ) [ sin ( \frac{n π {ϕ}_{p}}{180} ) - sin ( \frac{n π ( 2 {ϕ}_{p} + {α}_{1} )}{180} ) + sin ( \frac{n π ( {ϕ}_{p} + {α}_{1} )}{180} ) ] + \frac{1}{n} sin ( \frac{n πλ}{180} ) [ - cos ( \frac{n {πϕ}_{p}}{180} ) + cos ( 0 ) + cos ( \frac{n π ( 2 {ϕ}_{p} + {α}_{1} )}{180} ) - cos ( \frac{n π ( {ϕ}_{p} + {α}_{1} )}{180} ) ] \qquad ( 1 )$$

Where λ is the angle in degrees (i.e. the horizontal axis), ϕ_pis the width of the positive and negative pulses of V_LL in degrees, and α_1 is the width of first zero-step in degrees. As an example, these are shown in FIG. 6 where ϕ_p=90° and α_1=30°. For completion, the figure also shows α_2 which is the second zero-step. Both ϕ_p and α_1 can be defined piece-wise depending on the region of operation. In order to express these easily, define the conduction angle of the bridge legs to be ϕ_s so that the duty cycle is D=ϕ_s/(360°). Also define θ as the phase difference, in degrees, between each phase (in this case θ=120°). Thereafter, the angles are given as:

$${ϕ}_{p} = \{ \begin{matrix}{ϕ}_{s} & 0 ° \leq {ϕ}_{s} < 120 ° \\ θ & 120 ° \leq {ϕ}_{s} \leq 240 ° \\ 360 ° - {ϕ}_{s} & 240 ° < {ϕ}_{s} \leq 360 °\end{matrix}$$

$${α}_{1} = \{ \begin{matrix}θ - {ϕ}_{s} & 0 ° \leq {ϕ}_{s} < 120 ° \\ {ϕ}_{s} - θ & 120 ° \leq {ϕ}_{s} \leq 360 °\end{matrix}$$

$${α}_{2} = 360 ° - 2 {ϕ}_{p} - {α}_{1} ∀ {ϕ}_{s}$$

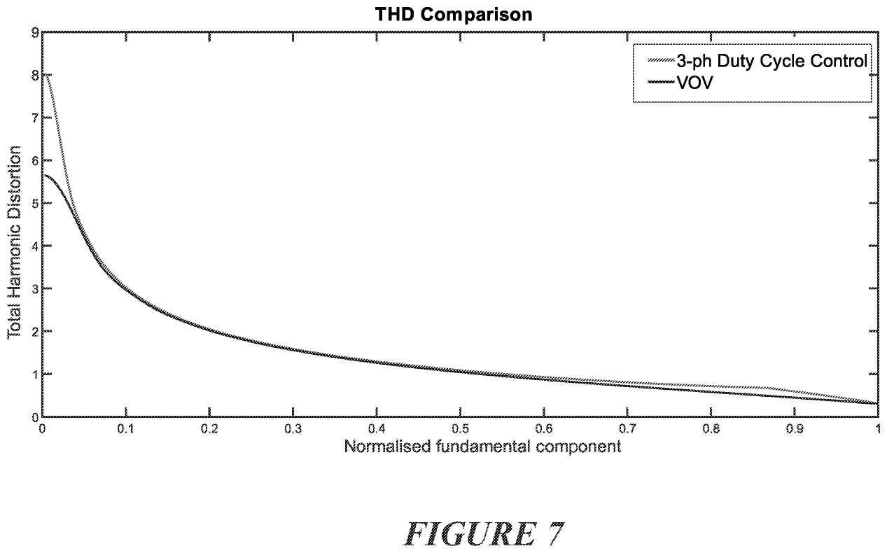

Since VOV control and duty cycle control use different control angles, it is difficult to draw a direct comparison between how the changes in control angles correspond to the THD in the line-to-line voltage. Instead, FIG. 7 compares the two control techniques by plotting the THD against the normalised fundamental component of each technique. This is because, for a given normalised fundamental component, the fundamental of the current will be the same. Thus, for a given power output, both control techniques must have the same normalised fundamental voltage. It is therefore useful to compare the THD against this metric.

As shown in FIG. 7, the THD of both techniques is almost the same in the region where the normalised fundamental is approximately 0.1 to 0.8. The duty cycle control technique has slightly greater THD, which is expected due to the asymmetry in the waveform. Nevertheless, both techniques have the same THD when the normalised fundamental component is 1, which is expected as they produce the standard six-step waveform at that operating point. For normalised fundamental values greater than 0.1, the greatest difference in THD is ≈0.184 which occurs at a normalised fundamental of ≈0.866. Overall, the small increase in THD is considered to be a minor drawback in comparison to the benefits of reducing the switching frequency by three-fold.

As mentioned before, the presence of the tuning networks in IPT systems can help eliminate DC biases from the system. This makes it possible to use asymmetrical duty cycles without saturating the couplers due to the DC biases that they introduce in the line-to-line voltages. The operating principle is similar to that described in FIG. 1, except the duty cycles of the line voltages are controlled independently. As such, three control angles are present instead of one. These are ϕ_A, ϕ_B, and ϕ_C and they correspond to the duty cycle of their respective line voltages. Furthermore, the phase angles can be changed by introducing two more control variables θ_B and θ_C which, respectively, correspond to the phases of the B phase and C phase.

The use of asymmetrical duty cycles can be useful for cases where the IPT couplers are misaligned, as this technique allows different phases to be energised to different levels. This is useful for when one or more of the couplers becomes misaligned and is no longer delivering power. This provides yet another advantage to IPT applications, as it allows some flexibility for adjustment when the system is operating under misaligned conditions. Due to the presence of more control variables, this technique is not straight-forward to approach analytically. Instead, the effect of using asymmetrical duty cycles on the line-to-line voltages was determined numerically.

In order to verify the behaviour expected from the mathematical models, a 3-phase delta-delta LCL-LCL compensated IPT system, shown in FIG. 7, was simulated in MATLAB Simulink using PLECS blockset. The system was driven using the proposed control technique, under symmetrical duty cycles, and it was designed to operate at 85 kHz with a nominal rated power of 11 kW. The system's specifications are listed in Table 1. The inductance and capacitance values were chosen to achieve the rated power output at k=0.1 whilst maintaining a small harmonic distortion in the bridge current. The inverter driving the system is shown in FIG. 1.

TABLE 1
Parameters used in simulation

| Rated output power | 11 | kW |
|---|---|---|
| Coupling factor | 0.1 to 0.3 | |
| Operating frequency | 85 | kHz |
| DC link voltage | 800 | V |
| Track inductance (Lₚₜₙ, Lₛₜₙ) | 100 | μH |
| Track series partial-tuning | 63.18 | nH |
| capacitance (C_{pn, ser}, C_{sn, ser}) | | |
| Parallel tuning capacitance (Cₚₜₙ, Cₛₜₙ) | 78.62 | nH |
| Inverter-side inductance (Lₚᵢₙ, Lₛᵢₙ) | 500 | μH |
| Inverter-side series partial-tuning | 7.70 | nH |
| capacitance (Cₚᵢₙ, Cₛᵢₙ) | | |

When fully tuned, the output power of the system is 11 kW at a coupling factor of 0.1.

When the coupling factor increases to 0.3, the output power increases by approximately nine-fold. In order to reduce the power back to 11 kW, the fundamental component of the input voltage needs to be reduced to one-third of its maximum value. Using the theoretical results arising from equation (1), the normalised fundamental was plotted as a function of ϕ_s as shown in FIG. 5. Through this, it was determined that at ϕ_s=40° and ϕ_s=320° the normalised fundamental would be approximately 1/3. Using this value in the simulation, it was verified that this does result in an output power of approximately 11 kW.

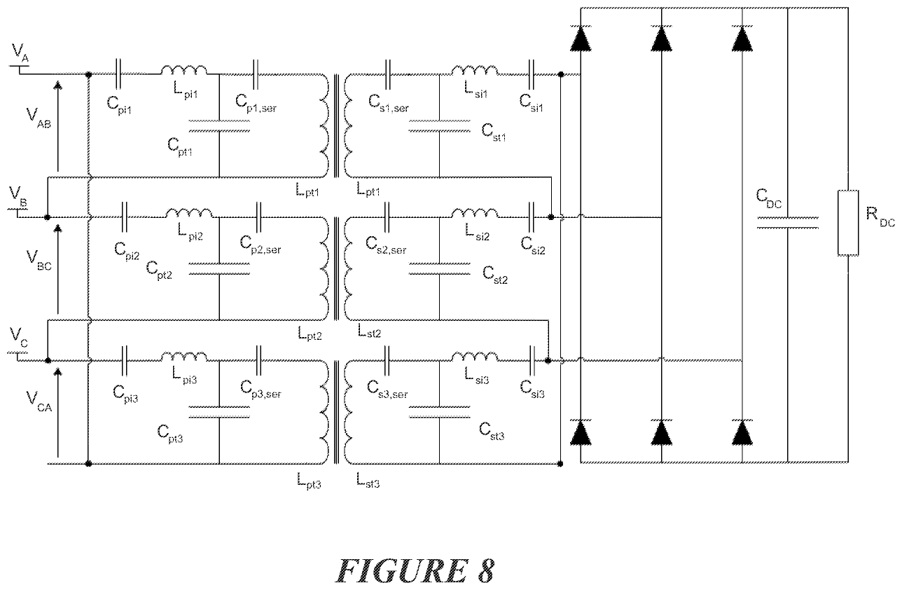

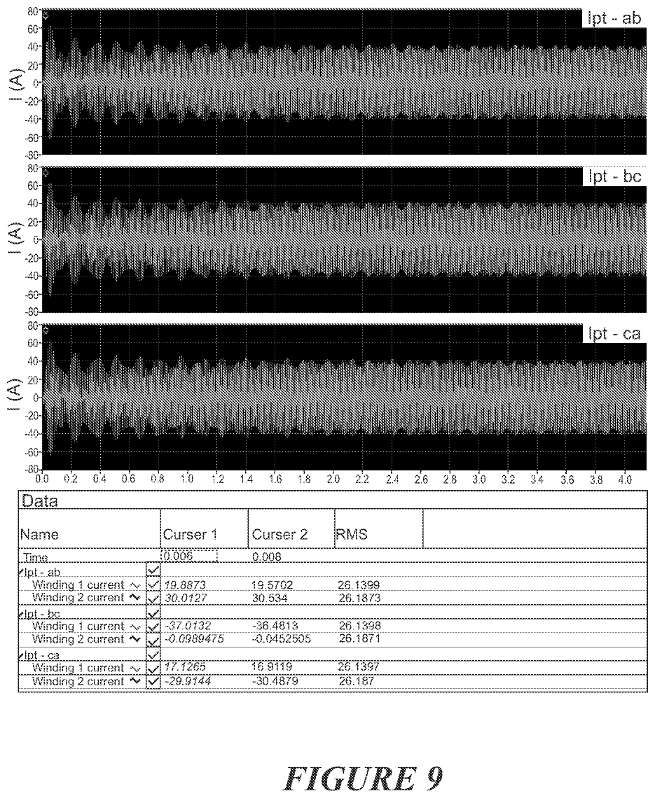

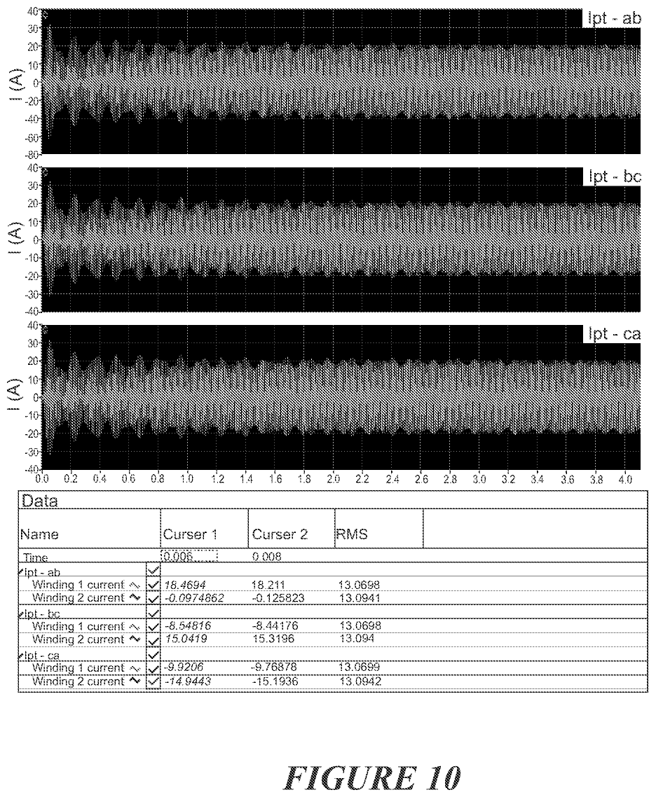

To illustrate this control method's ability to control the current, two cases are presented in FIG. 9 and FIG. 10. At ϕ_s=180°, and k=0.1, the tracks are operating at full-current. The simulation results for this are shown in FIG. 8, where the primary tracks have an RMS current of 26.19 A in the steady-state region. Note that the primary tracks are winding 2 in the figure.

In order to reduce the track currents to half of this value, at the same coupling factor, then the fundamental of line-to-line voltages needs to be halved. From FIG. 5, it can be seen that at ϕ_s=60°, the line-to-line voltages are at half of their maximum value. Using this control angle, it can be seen that the simulation results in FIG. 10 do indeed show the track currents halving in value, where the primary track currents are 13.1 A (RMS) in the steady-state region.

The system was then de-tuned by increasing L_pin to 550 μH in order to allow for the converter to soft-switch. However, doing so causes the power output to decrease. Nevertheless, this is easily addressed by adjusting ϕ_s according to the same plots used before (shown in FIG. 5). The detuned system was delivering approximately 10.4 kW at k=0.1 and 11 kW at k=0.3 while maintaining soft-switching for all edges. At k=0.3, the detuned system used ϕ_s=109.5°.

Although more sophisticated control may need to be employed in some practical systems, the open-loop control used in the simulation is sufficient to show that this modulation scheme can be used to effectively control a 3-phase IPT system. In addition, it does so while maintaining soft-switching and retains full control over the bridge current without requiring another converter to control the DC link voltage. Furthermore, the increase in THD, as compared to the VOV method, is small and it allows the switches to operate at the resonant frequency. Thus, it has clear advantages over the existing methods.

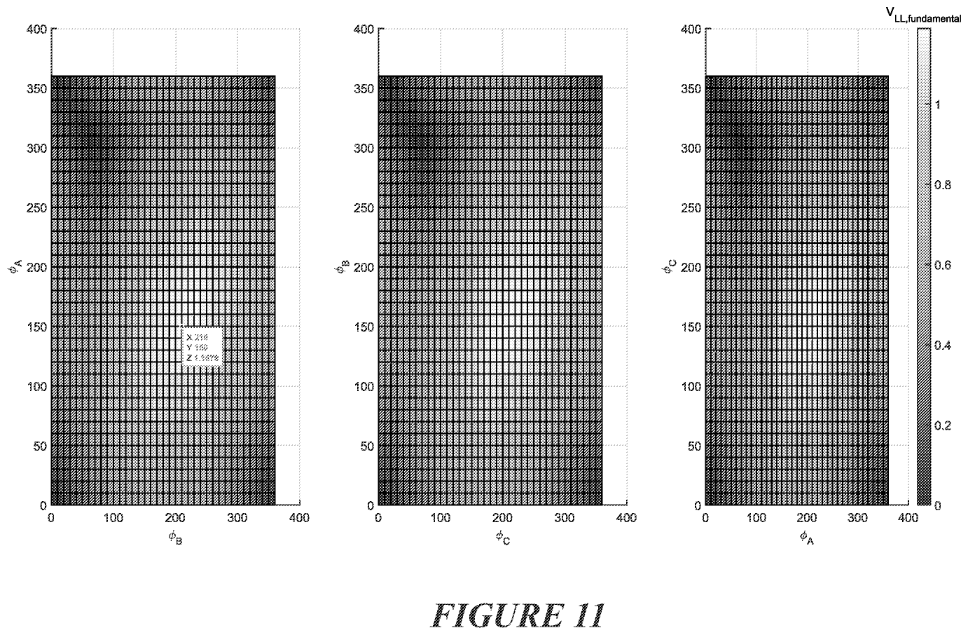

The effect of utilising asymmetrical duty cycles was determined numerically by computing the value of the fundamental component of each line-to-line voltage for every combination of ϕ_A, ϕ_B and ϕ_C, with a step size of 10° for each angle. The results are visualised using surface plots in MATLAB, as shown in FIG. 11. In FIG. 11, the X-Y view is shown while the fundamental component of the line-to-line voltages, which is the Z-axis, is represented as a colourmap. The figure shows how the fundamental component of each line-to-line voltage changes as its two corresponding control angles change. The leftmost plot corresponds to V_ab, the middle plot to V_bc, and the rightmost plot to V_ca. To allow the values to be easily scaled to any operating condition, the plots depict the case for when the DC-link voltage is 1V. As shown in the first subplot, the maximum fundamental value is ≅1.19V, which occurs for V_ab at ϕ_a=150° and ϕ_b=210°.

As seen in FIG. 11, each control angle affects two of the three line-to-line voltages. As such, it is not immediately obvious how to best select the control angles to achieve a given goal. Nevertheless, the use of asymmetrical duty cycles can be beneficial in several situations. For instance, if two phases need to be energised while the last one needs to be minimised. Such a situation can arise from coupler misalignment. For instance, if only V_bc and V_ca need to be energised then the control angles can be selected as ϕ_a=290°, ϕ_b=70°, and ϕ_c=180°. To make the comparison to the symmetrical case easier, the resulting V_LL values can be normalised about the ϕ_s=ϕ_a=ϕ_b=ϕ_c=180° operating point so that both cases are normalised about the same operating point. This allows a direct comparison to be made between the symmetrical and asymmetrical duty cycle cases. Proceeding with this, the above selected control angles result in V_ab(normalised)=0.06 and V_bc(normalised)=V_ca(normalised)=0.91. This shows that two line-to-line voltages can be balanced, and operate close to maximum, while the voltage across the third can be minimised.

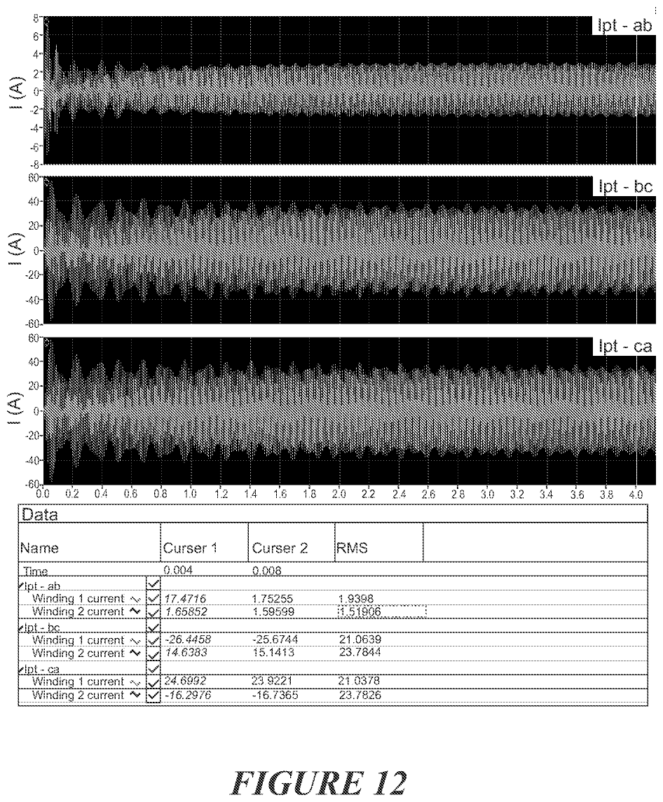

The simulation results for this case is shown in FIG. 12 which shows that the RMS primary track currents for the BC and CA phase are equal to each other, at an RMS value of 23.78 A in the steady-state region.

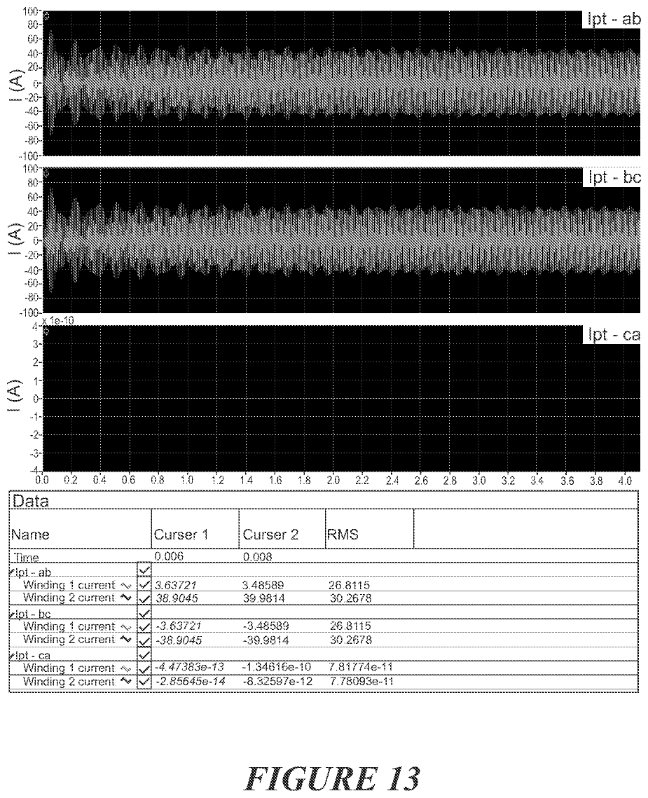

However, this particular situation is also addressed in literature through a different technique. The modulation technique uses equal duty cycles but changes the phase angles, where the A and B phases are kept 180 degrees out of phase and the C phase is made to be in-phase with the A phase. By using this configuration the AB and BC phases can be energised while the CA phase is turned off completely. The simulation results for this method can be seen in FIG. 13 where the primary currents are 30.27 A (RMS). As seen, in comparison to the proposed control method, this technique gives a slightly better performance for this particular situation. Using the same normalisation as above, this technique results in the ON phases having V_LL(normalised)=1.16 and the OFF phase having V_LL(normalised)=0. Thus, while using asymmetrical duty cycles in this situation is useful, it is not optimal.

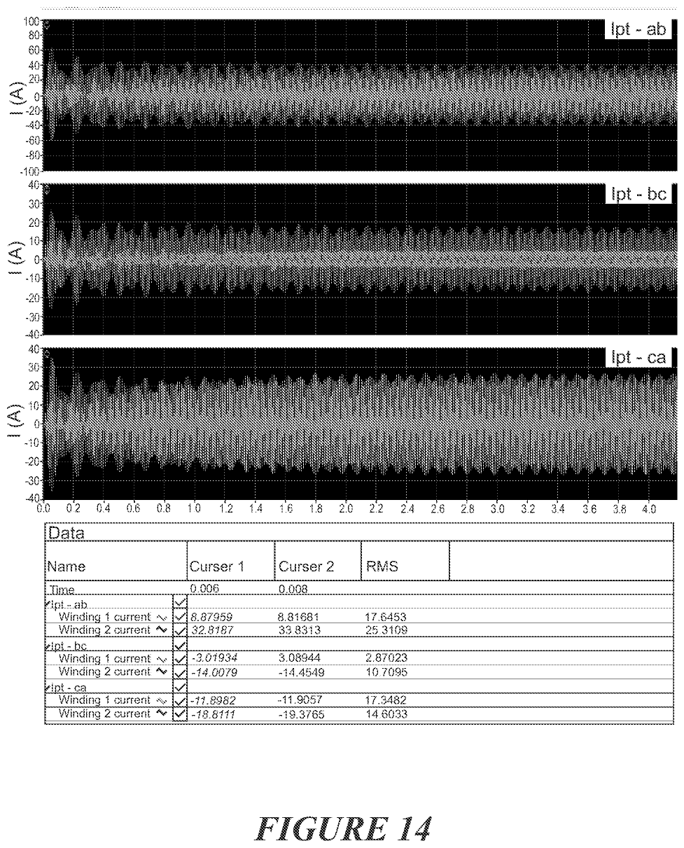

Nonetheless, the use of asymmetrical duty cycles is flexible enough to allow for adjustments to different situations. For instance, if one line-to-line voltage was to be maximised whilst the other two were to be minimized, then asymmetrical duty cycles can still be utilized. This is another situation that may arise due to misalignment. In order to find control angles that achieve this result, a simple optimization algorithm was developed to search the solution space represented in FIG. 11. The algorithm tries to minimize the difference between the fundamental components according to: |V_ab−(V_bc+V_ca)|. This was subject to the constraint that V_ab must be kept at a value ≥0.9 V_norm, where V_norm is the value of the line to line voltages when they form a standard six-step waveform (i.e. same normalisation point used for all of the examples above). Supposing that V_ab is to be maximised, and the other two are to be minimised, then using the optimization algorithm yields ϕ_A=150°, ϕ_B=270°, and ϕ_C=360°. This results in V_ab(normalised)=0.97, V_bc(normalised)=0.41, and V_ca(normalised)=0.56. The track currents for these control angles were also simulated and are shown in FIG. 14. This verifies that they are in the same proportions as the normalised line-to-line voltages.

These results are sufficient to show that there is merit to utilising the asymmetrical duty cycle operation disclosed herein in IPT systems. Furthermore, like the case of the symmetrical duty cycle, it will be apparent to those of skill in the art that a controller can be used to control the converter (i.e. H bridge) switches to implement the techniques disclosed herein in practice.

More examples of the modulation scheme described herein are presented in the unpublished draft conference paper, entitled “3 Phase Asymmetric Phase Modulation”, which is included in it's entirety in the priority patent application and incorporated herein by reference.

1-19. (canceled)

20. A method of controlling a polyphase converter associated with a polyphase wireless power transfer coupler, comprising switching the polyphase converter to produce a periodic voltage waveform of equal positive and negative pulse widths across at least one of a plurality of phase windings of the polyphase wireless power transfer coupler, wherein the periodic voltage waveform is asymmetric.

21. The method of claim 20, further comprising switching the converter to regulate the periodic voltage waveform across of the at least one of the phase windings to control a circulating current in a compensation network of the phase windings.

22. The method of claim 20, further comprising switching the converter to regulate the periodic voltage waveform to control a RMS current in the at least one of the phase windings.

23. The method of claim 20, further comprising switching the converter to switch the at least one of the phases windings of the polyphase wireless power transfer coupler with a different pulse width to create a DC bias.

24. The method of claim 20, further comprising filtering a DC bias across the at least one of the phase windings of the polyphase wireless power transfer coupler with a compensation network of at least one phase windings.

25. The method of claim 20, further comprising switching the converter to apply a respective pair of line-in-neutral voltages to each phase winding, and a corresponding respective line-to-line voltage across each phase winding.

26. The method of claim 20, further comprising non-reciprocatingly switching switches in each converter leg corresponding to the at least one of the phase windings.

27. The method of claim 20, wherein the periodic voltage waveform is asymmetric in phase.

28. The method of claim 20, wherein the periodic voltage waveform is asymmetric in a first power range and symmetric in a second power range higher than the first power range.

29. The method of claim 28, wherein the periodic voltage waveform is asymmetric in a third power range higher than the second power range.

30. The method of claim 20, further comprising switching the polyphase converter so that a delivery power is inversely proportional to one of:
a coupling factor between the at least one of the phase windings and an associated winding; and
a system tuning factor.

31. The method of claim 20, wherein the periodic voltage waveform complies with:
$${ϕ}_{p} = \{ \begin{matrix}{ϕ}_{s} & 0 ° \leq {ϕ}_{s} < 120 ° \\ θ & 120 ° \leq {ϕ}_{s} \leq 240 ° \\ 360 ° - {ϕ}_{s} & 240 ° < {ϕ}_{s} \leq 360 °\end{matrix}$$
$${α}_{1} = \{ \begin{matrix}θ - {ϕ}_{s} & 0 ° \leq {ϕ}_{s} < 120 ° \\ {ϕ}_{s} - θ & 120 ° \leq {ϕ}_{s} \leq 360 °\end{matrix}$$
$${α}_{2} = 360 ° - 2 {ϕ}_{p} - {α}_{1} ∀ {ϕ}_{s}$$
where ϕ_{P} represents a width of each of positive and negative pulses, ϕ_{S} represents a conduction angle of each of positive and negative pulse bridge legs, θ represents a phase difference between the positive and negative pulse bridge legs, α1 represents a zero-step width between each positive pulse and a following negative pulse, and α2 represents a zero-step width between each negative pulse and a following positive pulse.

32. The method of claim 20, further comprising:
switching a first switch pair and a second switch pair of the polyphase converter in relation to a first one of the phase windings;
switching the second switch pair and a third switch pair of the polyphase converter in relation to a second one of the phase windings; and
switching the third switch pair and the first switch pair of the polyphase converter in relation to a third one of the phase windings.

33. A controller to be associated with a polyphase converter and a polyphase wireless power transfer coupler, the controller being configured to perform the method of claim 20.

34. A method of controlling a polyphase converter associated with a polyphase wireless power transfer coupler, comprising:
switching the polyphase converter to produce a first phase voltage and a second phase voltage that form a first periodic voltage waveform across a first phase winding of the coupler;
switching the polyphase converter to produce the second phase voltage and a third phase voltage that form a second periodic voltage waveform across to a second phase winding of the coupler; and
controlling the polyphase converter to reduce energisation of the first phase winding relative to the second winding.

35. The method of claim 34, wherein reducing energisation comprises causing a pulse width of one of the first and second phase voltages to be different from that of the other.

36. The method of claim 35, further comprising:
switching the polyphase converter to produce the third phase voltage and the first phase voltage that form a third periodic voltage waveform across to a third phase winding of the coupler; and
controlling the polyphase converter to reduce energisation of the third phase winding relative to the second phase winding,
wherein the polyphase converter is controlled based on a minimization of:

|V₂₃−(V₃₁+V₁₂)|

wherein V₁₂, V₂₃ and V₃₁ represent respective fundamental components of the first, second and third periodic voltage waveforms.

37. The method of claim 34, wherein reducing energisation comprises adjusting a phase difference between the first and second phase voltages.

38. The method of claim 37, wherein the first phase voltage has a pulse width identical to that of the second phase voltage.

39. A controller to be associated with a polyphase converter and a polyphase wireless power transfer coupler, the controller being configured to perform the method of claim 34.
